(19) United States
(12) Patent Application Publication
(10) Pub. No.: US 2004/0174774 A1
(43) Pub. Date: Sep. 9, 2004

(54) Electronic timepiece apparatus

(75) Inventors: Hideo Tasaka, Tokyo (JP); Hiroyuki Abe, Tokyo (JP); Shunji Minami, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/792,444

(22) Filed: Mar. 2, 2004

(30) Foreign Application Priority Data
Mar. 6, 2003 (JP) 2003-059650

(51) Int. Cl. G02F 1/1347; G04C 19/00

(52) U.S. Cl. 368/84

(57) ABSTRACT

An electronic timepiece apparatus comprises a time-display hand unit having a dial plate and hands that sweep above the dial plate, a first liquid crystal display unit which is disposed above the time-display hand unit, and a second liquid crystal display unit which is disposed below the time-display hand unit. Information displayed on the second liquid crystal display unit is visible from above the first liquid crystal display unit through the dial plate and the first liquid crystal display unit.

### CROSS-REFERENCE TO RELATED APPLICATIONS

This application is based upon and claims the benefit of priority from prior Japanese Patent Application No. 2003-059650, filed Mar. 6, 2003, the entire contents of which are incorporated herein by reference.

### BACKGROUND OF THE INVENTION

1. Field of the Invention

The present invention relates to electronic timepiece apparatus such as electronic wristwatches.

2. Description of the Related Art

In a conventional electronic wristwatch, a time-display hand unit whose hands (hour, minute and second hands) sweep around a drive shaft above a dial plate to thereby indicate time and a liquid crystal display panel disposed above the hand unit to electro-optically display numerical information such as time and others are included in a timepiece module case.

In such an electronic wristwatch, the time-display hand unit is capable of indicating time analogly and the liquid crystal display panel is capable of displaying information such as time digitally. However, since the liquid crystal display panel is merely disposed above the time-display hand unit, the number of items of information that can be displayed on the liquid crystal display panel is limited. That is, a large number of items of information cannot be displayed. For the same reason, when the liquid crystal display panel displays information in its information display area that faces that of the time-display hand unit, the time-display hand unit becomes considerably difficult to view.

### BRIEF SUMMARY OF THE INVENTION

It is an object of the present invention to provide an electronic timepiece apparatus capable of displaying a number of pieces of information to thereby display information on the multiple functions of the apparatus.

Another object of the present invention is to provide an electronic timepiece apparatus that a user is able to view the time-display hand unit although the liquid crystal display unit is disposed above the time-display hand unit.

According to an embodiment of the present invention, an electronic timepiece apparatus comprises a time-display hand unit having a dial plate and hands that sweep above the dial plate, a first liquid crystal display unit which is disposed above the time-display hand unit, and a second liquid crystal display unit which is disposed below the time-display hand unit, wherein information displayed on the second liquid crystal display unit is visible from above the first liquid crystal display unit through the dial plate and the first liquid crystal display unit.

According to another embodiment of the present invention, an electronic timepiece apparatus comprises a time-display hand unit having a dial plate and hands that sweep above the dial plate, a first liquid crystal display unit disposed above the time-display hand unit, and a second liquid crystal display unit which is disposed at a side of the first liquid crystal display unit.

According to still another embodiment of the present invention, an electronic timepiece apparatus comprises a time-display hand unit having a dial plate and hands that sweep above the dial plate, and a liquid crystal display unit which is disposed above the time-display hand unit and comprises a first display area that faces a first area of the dial plate surrounded by hour markers arranged on the dial plate and a second display area that faces a second area of the dial plate other than the first area, the first and second display areas presenting different display states.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a front view of a first embodiment of an electronic wristwatch according to the invention;

FIG. 2 is an enlarged cross-sectional view taken along a line II-II of FIG. 1;

FIG. 3 is a front view of the electronic wristwatch of FIG. 1 when only the first liquid crystal display unit displays information;

FIG. 4 is a front view of the electronic wristwatch of FIG. 1 when both the first and second liquid crystal display units display information;

FIG. 5 is a front view of a second embodiment of the electronic wristwatch according to the invention;

FIG. 6 is an enlarged cross-sectional view taken along a line VI-VI of FIG. 5;

FIG. 7 is a front view of the electronic wristwatch of FIG. 5 when only the first liquid crystal display unit displays information;

FIG. 8 is a front view of the electronic wristwatch of FIG. 5 when both the first and second liquid crystal display units display information;

FIG. 9 is a front view of a third embodiment of an electronic wristwatch according to the invention;

FIG. 10 is an enlarged cross-sectional view taken along a line X-X of FIG. 9;

FIG. 11 is a front view of the wristwatch of the third embodiment when the first and third liquid crystal display units display information;

FIG. 12 is a front view of the wristwatch of the third embodiment when all the first-third liquid crystal display units display information;

FIG. 13 is a front view of a fourth embodiment of the electronic wristwatch according to the invention;

FIG. 14 is an enlarged cross-sectional view taken along a line XIV-XIV of FIG. 13;

FIG. 15 is a front view of the electronic wristwatch of FIG. 13 when the first and third liquid crystal display units display information;

FIG. 16 is a front view of the electronic wristwatch of FIG. 13 when all the first-third liquid crystal display units display information;

FIG. 17 is a front view of a fifth embodiment of the electronic wristwatch according to the invention;

FIG. 18 is an enlarged cross-sectional view taken along a line XVIII-XVIII of FIG. 17;

FIG. 19 is a front view of a sixth embodiment of the electronic wristwatch according to the invention;

FIG. 20 is an enlarged cross-sectional view taken along a line XX-XX of FIG. 19;

FIG. 21 is a plan view of a first and a second display area of a first liquid crystal display panel of FIG. 20;

FIG. 22 is a front view of a seventh embodiment of the electronic wristwatch according to the invention;

FIG. 23 is an enlarged cross-sectional view taken along a line XXIII-XXIII of FIG. 22;

FIG. 24 is a plan view of a first and a second display area of the first liquid crystal display panel of FIG. 23;

FIG. 25 is a front view of a modification of the electronic wristwatch of the sixth and seventh embodiments shown in FIGS. 19 and 22; and

FIG. 26 is a plan view of a first and a second display area of the first liquid crystal display panel of FIG. 25.

### DETAILED DESCRIPTION OF THE INVENTION

An embodiment of an electronic wristwatch according to the present invention will now be described with reference to the accompanying drawings.

(First Embodiment)

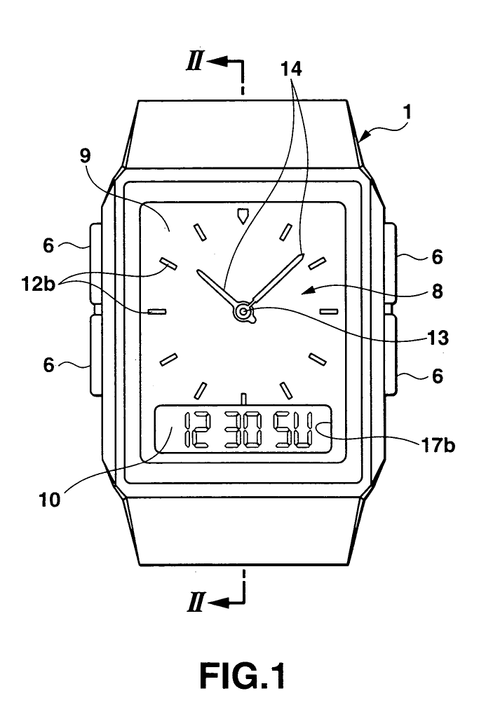

Referring to FIGS. 1-4, a first embodiment of the electronic wristwatch as the electronic timepiece apparatus according to the present invention will be described.

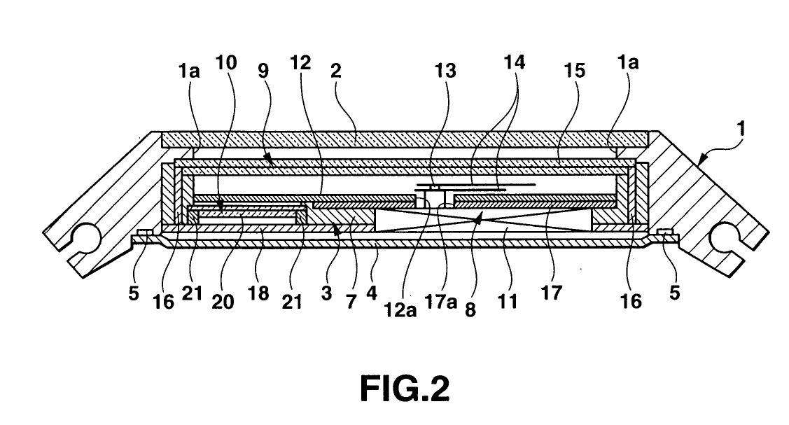

FIG. 1 is a front view of the electronic wristwatch. FIG. 2 is an enlarged cross-sectional view taken along II-II of FIG. 1. The electronic wristwatch has a case 1 over which as shown in FIG. 2, a crystal 2 is provided. A timepiece module 3 is housed within the case 1 whose lower end is closed with a back cover 4 through a waterproof ring 5. As shown in FIG. 1, a plurality of push button switches 6 are provided on the case 1 at three and nine o'clock.

As shown in FIG. 2, the timepiece module 3 comprises a time-display hand unit 8, a first liquid crystal display unit 9 and a second liquid crystal display unit 10 housed within a generally shell- or box-like housing 7. More particularly, the time-display hand unit 8 comprises an analog movement 11 provided within the housing 7 and a dial plate 12 provided on the open upper end of the housing 7. A hand shaft 13 of the analog movement 11 extends upward through a hole 12a in the dial plate 12 with the shaft 13 having hands (hour, minute and second hands) 14 on its top such that the hands 14 sweep above the dial plate 12 to thereby indicate time. In this case, the dial plate 12 is made of transparent or translucent plastic with the hour numerals disposed at substantially equal intervals along a circle.

As shown in FIG. 2, the first liquid crystal display unit 9 has a first liquid crystal display panel 15 disposed above the time-display hand unit 8 or the hands 14 and covering substantially the whole area of the dial plate 12. The first liquid crystal display panel 15 abuts on its opposite sides on a lower surface of a collar 1a provided on the inner surface of the case 1 and supported by a pair of electrically conductive interconnectors 16 each provided on a respective one of the opposite sides of the housing 7. The first liquid crystal display panel 15 comprises a pair of transparent electrode plates (not shown) between which liquid crystal is filled, a pair of polarizer plates (not shown) each provided on a respective one of an upper surface of the upper electrode and a lower surface of the lower electrode. By applying voltages across the pair of electrodes selectively, information such as time is displayed electro-optically on the display panel 15.

As shown in FIG. 2, a flat electroluminescence element 17 is disposed as a backlight device for the first liquid crystal display panel 15 on a lower surface of the transparent or translucent dial plate 12. The electroluminescence element 17 comprises a light source of a flat-surface electroluminescence type with the hand shaft 13 extending through a hole 17a in the electroluminescence element 17. The electroluminescence element 17 has a substantially rectangular opening 17b having the same size as, and aligning with, the second liquid crystal display unit 10 (FIG. 1). Light based on the surface electroluminescence passes through the dial plate 12 excluding the hole 17a and the opening 17b to thereby illuminate the lower surface of the first liquid crystal display panel 15. The pair of electrically conductive interconnectors 16 extend vertically through the dial plate 12 at opposite positions, respectively, and are at their upper and lower ends in contact with the respective terminals (not shown) of the first liquid crystal display panel 15 and the terminals (not shown) of a circuit board 18 provided on its lower surface provided on a lower end of the housing 7 to thereby electrically connect the first liquid crystal display panel 15 and the circuit board 18.

As shown in FIG. 2, the second liquid crystal display unit 10 comprises a second liquid crystal display panel 20 disposed below the dial plate 12 of the time-display hand unit 8, more particularly, below the electroluminescence element 17 that in turn is disposed on a lower surface of the dial plate 12 so as to have the same size as, and aligning with, the opening 17b in the electroluminescence element 17. The second liquid crystal display panel 20 is supported at its opposite ends by a pair of electrically conductive interconnectors 21 so as to be in electrical contact with the circuit board 18. Like the first liquid crystal display panel 15, the second liquid crystal display panel 20 comprises a pair of upper and lower transparent electrode plates (not shown) between which liquid crystal is filled, and a pair of polarizer plates (not shown) each provided on a respective one of an upper surface of the upper electrode plate and a lower surface of the lower electrode plate, and a reflector (not shown) provided on a lower surface of the lower polarizer plate. Thus, by applying voltages selectively across the pair of electrode plates, information such as time is displayed electro-optically on the second display panel 20 and can be viewed from above through the opening 17b in the electroluminescence element 17, the dial plate 12 and the first liquid crystal display panel 15.

As shown in FIG. 1, since in this wristwatch the time-display hand unit 8 is visible through the first liquid crystal display panel 15 and the crystal 2 from outside the case 1, the time indicated by the hands 14 that sweep above the dial plate 12 is visible. By operating the plurality of push button switches 6 provided on the side of the case 1 to thereby drive only the second liquid crystal display unit 10, information such as time is displayed on the second liquid crystal display panel 20, as shown in FIG. 1. Since at this time the second display panel 20 is illuminated with external light, the information displayed on the second display panel 20 can be viewed from outside the case 1 through the opening 17b in the electroluminescence element 17, the dial plate 12, the first liquid crystal display panel 15 and the crystal 2. Thus, time can be known from the time-display hand unit 8 and the information displayed on the second liquid crystal display panel 20 can be recognized visually.

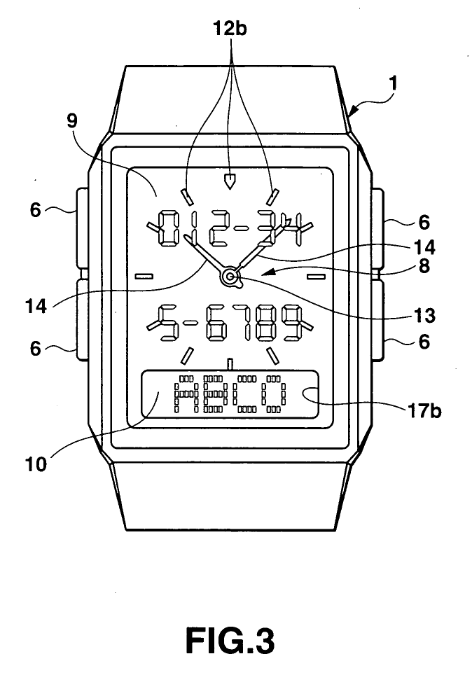

When in this state the plurality of push button switches 6 are appropriately operated to thereby drive the first liquid crystal display unit 9, the electroluminescence element 17 becomes surface-luminous to thereby display information such as time on the whole surface of the first liquid crystal display unit 9, as shown in FIG. 3. Since at this time the light emitted from the surface of the electroluminescence element 17 passes through the dial plate 12 and illuminates the lower surface of the first liquid crystal display panel 15. Thus, the user can view the information displayed on the whole surface of the first liquid crystal display panel 15 through the crystal 2 from outside the case 1. Thus, the user can know time from the time-display hand unit 8 and visually recognize the information displayed on the first liquid crystal display panel 15.

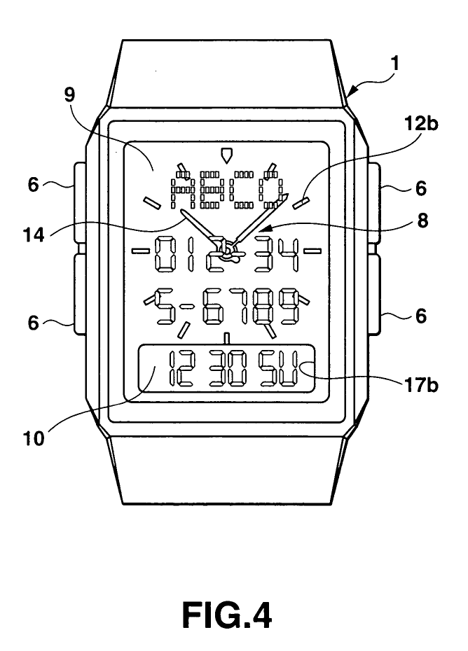

Further, when the plurality of push button switches 6 are appropriately operated to thereby drive the first and second liquid crystal display units 9 and 10, the electroluminescence element 17 becomes surface-luminous to thereby display different information on the first and second liquid crystal display panels 15 and 20, as shown in FIG. 4. At this time, the first liquid crystal display panel 15 displays information on the electroluminescence element 17 except for the opening 17b whereas the second liquid crystal display panel 20 displays information different from that displayed by the first liquid crystal display panel 15. In this state, the first liquid crystal display panel 15 is illuminated with the light from the first liquid crystal display panel 15. Thus, the user can view the information displayed on the first liquid crystal display panel 15 through the crystal 2 from outside the case 1, as in the above case.

Since at this time the second liquid crystal display panel 20 is illuminated with both the external light and the light emitted by the electroluminescence element 17, the information displayed on the second liquid crystal display panel 20 different from that displayed on the first liquid crystal display panel 15 can be viewed from outside the case 1 through the opening 17b in the electroluminescence element 17, the first liquid crystal display panel 15 and the crystal 2. Thus, the time can be known from the time-display hand unit 8 and the information displayed on both the first and second liquid crystal display panels 15 and 20 can be viewed well because they do not overlap.

In conclusion, according to this electronic wristwatch the first panel 15 of the first liquid crystal display unit 9 is disposed above the time-display hand unit 8, and the second panel 20 of the second liquid crystal display unit 10 is disposed below the time-display hand unit 8. Thus, the information displayed on the second liquid crystal display panel 20 can be viewed from above through the opening 17a in the electro-luminescence element 17, the dial plate 12, and the first panel 15 of the first liquid crystal display unit 9. Thus, time can be known from the time-display hand unit 8 and different information displayed on the respective first and second liquid crystal display units 9 and 10 can be viewed. Thus, compared to the wristwatch that comprises only the first liquid crystal display unit 9 in addition to the time-display hand unit 8, the wristwatch that comprises the first and second liquid crystal display units 9 and 10 in addition to the time-display hand unit 8 can display more information to thereby display information on the multiple functions of the timepiece apparatus accordingly.

Other embodiments of the electronic wristwatch according to the present invention will be described. The same portions as those of the first embodiment will be indicated in the same reference numerals and their detailed description will be omitted.

(Second Embodiment)

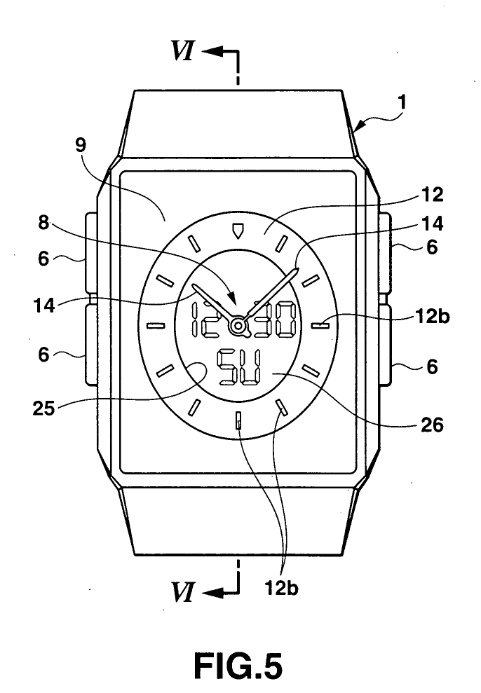

Next, referring to FIGS. 5-8 a second embodiment of the electronic wristwatch according to the invention will be described.

The electronic wristwatch of this embodiment has substantially the same structure as the first embodiment excluding that the dial plate 12 of the time-display hand unit 8 takes the form of a transparent disc with a central circular opening 25, that the second liquid crystal display unit 26 is disposed on a lower surface of the dial plate 12, and that the electroluminescence element 17 is disposed on a lower surface of the second panel 27 of the second liquid crystal display unit 26.

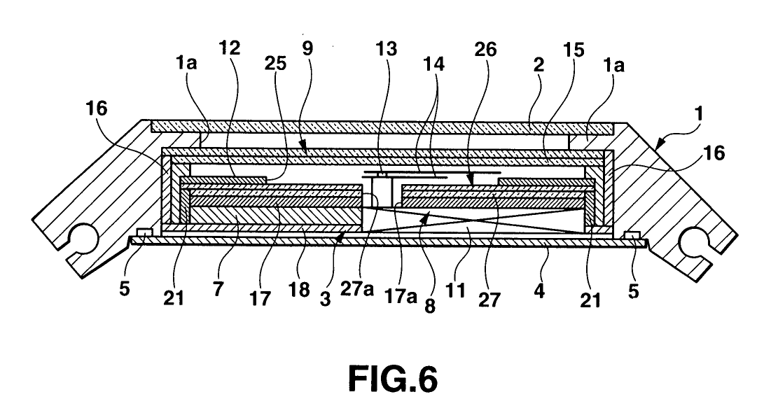

As shown in FIG. 6, the second liquid crystal display panel 27 has the same size as the dial plate 12 and is provided on the lower surface of the dial plate 12. The second liquid crystal display panel 27 is supported at its opposite ends within the housing 7 by the pair of electrically conductive interconnectors 21 such that the second panel 27 is electrically connected to the circuit board 18. Like the first liquid crystal panel 15, the second panel 27 has a transparent construction that comprises a pair of upper and lower transparent electrode plates (not shown) between which liquid crystal is filled, a pair of polarizer plates (not shown) each provided on a respective one of an upper surface of the upper electrode plate and a lower surface of the lower electrode. Thus, by applying voltages selectively across the pair of electrode plates, information such as time is displayed on the second panel 27 electro-optically.

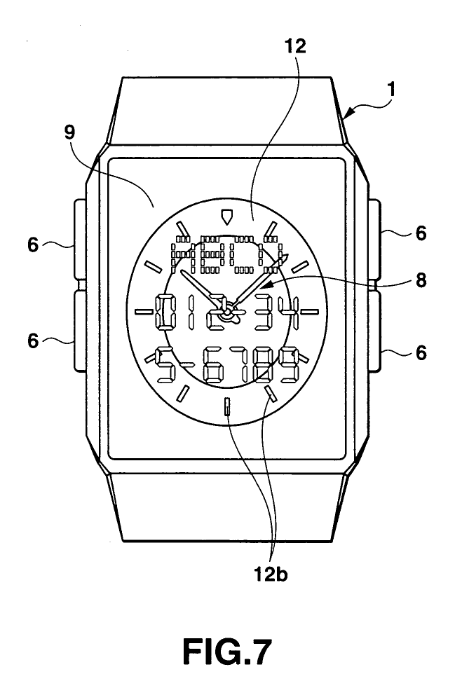

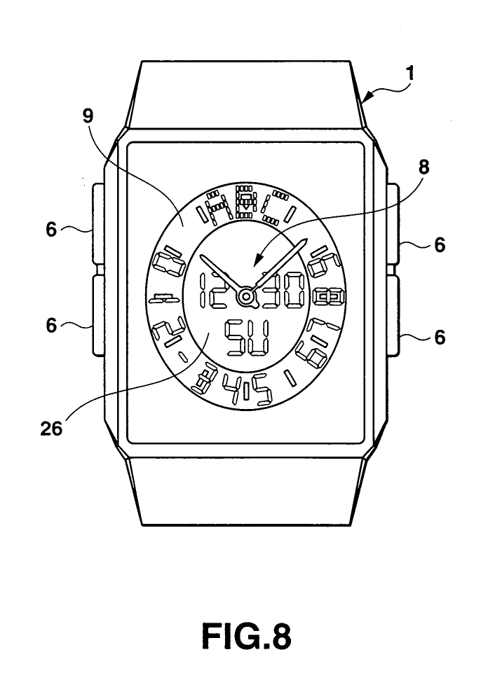

The second panel 27 has a central opening 27a through which the hand shaft 13 extends. The display area of the second panel 27 is limited to the one that corresponds to the circular opening 25 in the dial plate 12 and its other area is always transparent. The electroluminescence element 17 takes the form of a disc having substantially the same size as the second liquid crystal display panel 27 and has a central hole 17a through which the hand shaft 13 extends such that the light based on the surface luminescence illuminates the lower surface of the second liquid crystal display panel 27, then passes through the second panel 27 and the dial plate 12 to thereby illuminate the lower surface of the first liquid crystal display panel 15. The first panel 15 is arranged such that its display switches between a first display state (FIG. 7) that displays information on the whole area of the dial plate 12 and a second display state (FIG. 8) that displays information on a ring-like area excluding the area corresponding to the opening 25 in the dial plate 12.

As in the first embodiment, in this electronic wristwatch the present time can be recognized by viewing the hands that sweep above the dial plate 12 from outside the case 1 through the first liquid crystal display panel 15 and the crystal 2. When the plurality of push button switches 6 are operated appropriately in this state to thereby drive only the second liquid crystal display unit 26, the electroluminescence element 17 becomes surface-luminous to thereby display information such as time only on the second liquid crystal display panel 27, as shown in FIG. 5. Thus, the information displayed on the second liquid crystal display panel 27 can be viewed from outside the case 1 through the opening 25 in the dial plate 12, the first liquid crystal display panel 15 and the crystal 2. As a result, the present time can be known from the time-display hand unit 8 and the information displayed on the second liquid crystal display panel 27 can be recognized visually.

When the plurality of push button switches 6 are operated appropriately in this state to thereby drive only the first liquid crystal display unit 9, the electroluminescence element 17 becomes surface-luminous to thereby display information such as time on the first liquid crystal display panel 15, as shown in FIG. 7. At this time, the first liquid crystal display panel 15 presents the first display state to thereby display information on the whole upper area of the dial plate 12 and the light based on the electroluminescence element 17 passes through the second liquid crystal display panel 27 and the dial plate 12 to thereby illuminate the lower surface of the first liquid crystal display panel 15. Thus, as in the first embodiment the information displayed on the first liquid crystal display panel 15 can be viewed from outside the case 1 through the crystal 2. Thus, time can be known from the time-display hand unit 8 and the information displayed on the first liquid crystal display panel 15 can also be recognized visually.

When the plurality of push button switches 6 are also operated appropriately to thereby drive the respective first and second liquid crystal display units 9 and 26, the electroluminescence element 17 becomes surface-luminous to thereby display different information on the first and second liquid crystal display panels 15 and 27, respectively, as shown in FIG. 8. At this time the first liquid crystal display panel 15 presents the second display state to thereby display information on the ring-like area excluding its area corresponding to the opening area 25 in the dial plate 12 and the second liquid crystal display panel 27 displays information only on its area that corresponds the opening 25 in the dial plate 12. The light emitted from the electroluminescence element 17 illuminates the second liquid crystal display panel 27, and then passes through the second liquid crystal display panel 27 and the dial plate 12 to thereby illuminate the lower surface of the first liquid crystal display panel 15.

Thus, as shown in FIG. 8 the information displayed on the first liquid crystal display panel 15 can be viewed from outside the case 1 through the crystal 2. Further, the information displayed on the second liquid crystal display panel 27 can be viewed from outside the case 1 through the opening 25 in the dial plate 12, the first liquid crystal display panel 15, and the crystal 2. In this case, the information displayed on the first panel 15 does not overlap with the information displayed on the second panel 27, so that time can be known from the time-display hand unit 8 and the different information displayed on the first and second liquid crystal display panels 15 and 17 can be viewed well, respectively.

As described above, time can be known from the time-display hand unit 8 of this electronic wristwatch as in the first embodiment. Further, different information can be displayed on the respective first and second liquid crystal display units 9 and 26. Thus, compared to the electronic wristwatch in which only the first liquid crystal display unit 9 is provided in addition to the time-display hand unit 8, the electronic wristwatch of this embodiment is capable of displaying more information by an amount of information displayed by the second liquid crystal display unit 26 to thereby display information on the multiple functions of the timepiece apparatus. Especially, the first panel 15 switches between its first display state that displays information on the whole upper area of the dial plate 12 and the second display state that displays information on the area of the dial plate 12 excluding its opening 25. Thus, when only the first liquid crystal display unit 9 is driven, the first panel 15 displays information on the whole upper area of the dial plate 12 whereas when both the first and second liquid crystal display units 9 and 26 are driven, the first panel 15 displays information on the area of the dial plate 12 excluding its opening 25, so that the information displayed on both the first and second panels 15 and 17 do not overlap to thereby allow the user to view the information well.

(Third Embodiment)

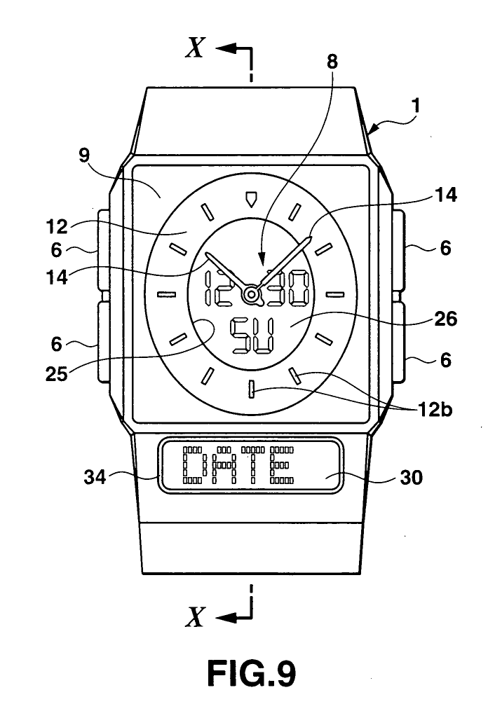

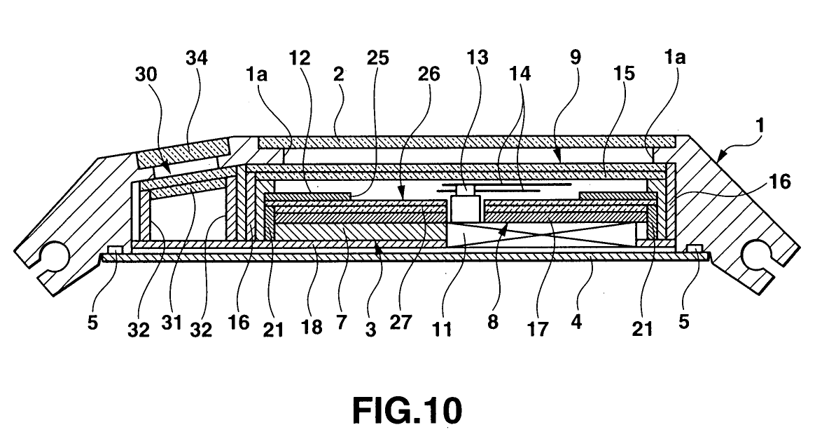

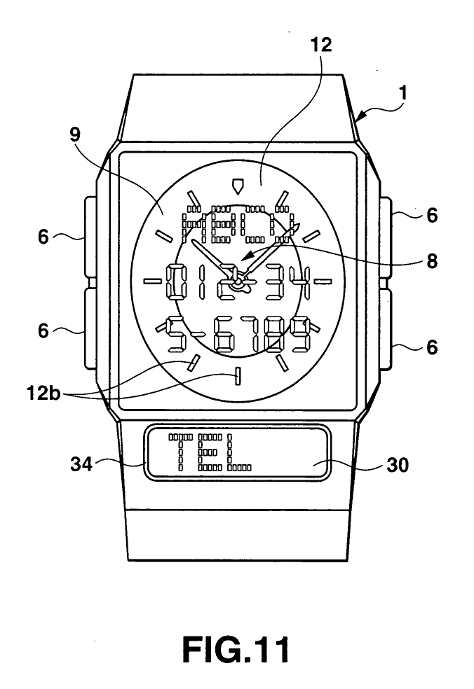

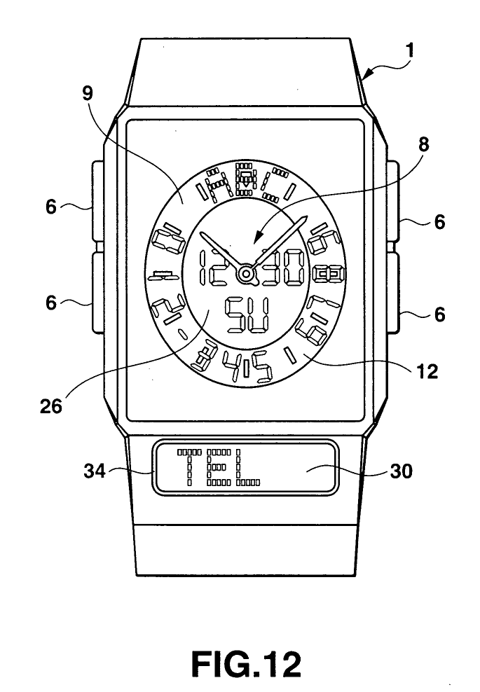

Next, referring to FIGS. 9-12, a third embodiment of the electronic wristwatch according to the present invention will be described.

This electronic wristwatch has substantially the same structure as the second embodiment excluding that a third liquid crystal display unit 30 is provided on the timepiece module 3 at 6 o'clock. More particularly, the third liquid crystal display unit 30 comprises a third liquid crystal display panel 31 that displays information electro-optically. The third panel 31 is disposed within the case 1 at the side of the first panel 15 with being slightly tilted to the surface of the panel 15 and supported at its both ends by the interconnectors 32 so as to be connected electronically to the circuit board 18.

Like the second liquid crystal display panel 20 of the first embodiment, the third panel 31 has the reflective construction that comprises the pair of upper and lower transparent electrode plates between which liquid crystal is filled, the pair of polarizer plates each provided on the respective one of the upper surface of the upper electrode plates and the lower surface of the lower electrode plates, and the reflector provided on the lower surface of the lower polarize plate such that by applying voltages selectively across the pair of electrode plates, various information such as a telephone number can be displayed on the third panel 31. In this case, a part of the upper surface of the case 1 is composed of a protective crystal 34 provided above the third panel 31. Thus, the third panel 31 is illuminated with external light entering through the protective crystal 34 and the displayed information can be viewed from outside the case 1 through the protective crystal 34.

As in the second embodiment, in this wristwatch time can be known from the time-display hand unit 8 and different information can be displayed on both the first and second liquid crystal display units 9 and 26, respectively. Especially, information can also be displayed on the third panel 31 of the third liquid crystal display unit 30 and viewed through the protective crystal 34. Thus, more information can be displayed by an amount of information displayed by the third liquid crystal display unit 30 to thereby display information on the multiple functions of the timepiece apparatus.

(Fourth Embodiment)

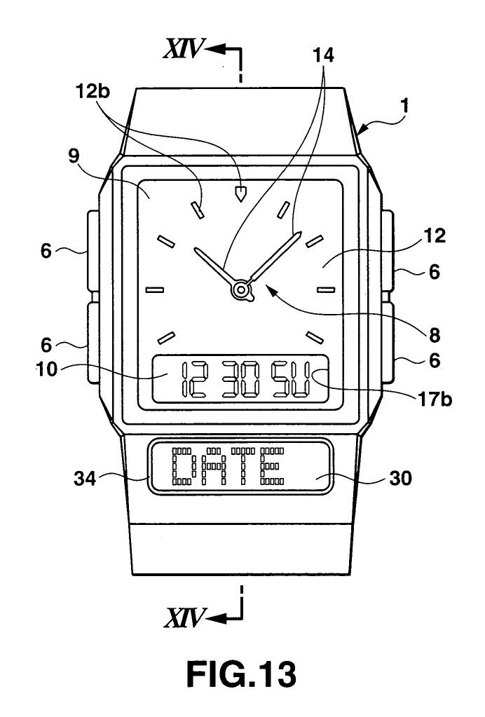

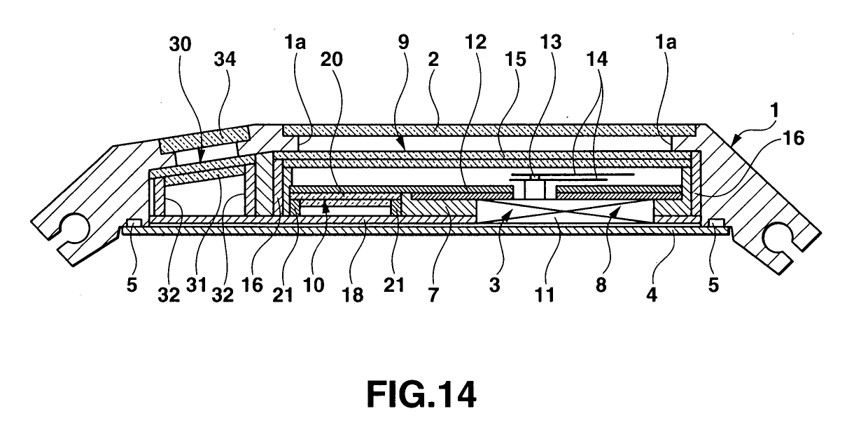

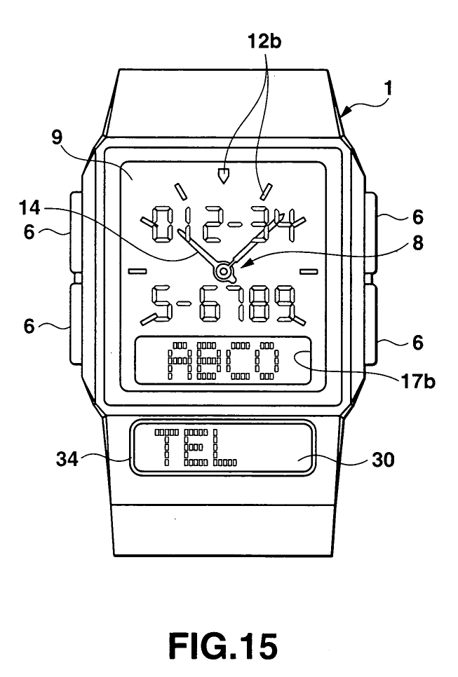

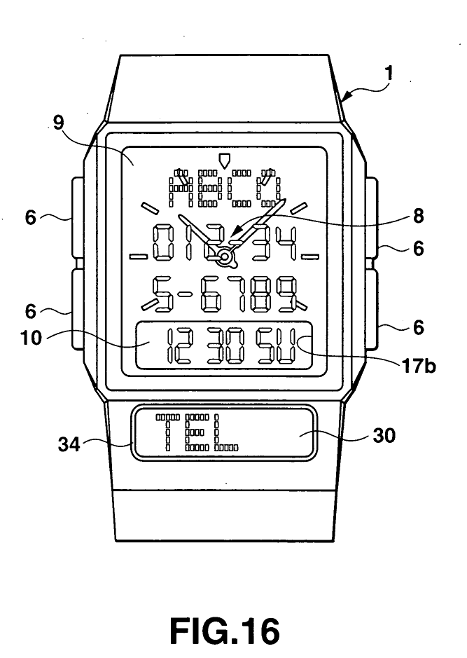

Then, referring to FIGS. 13-16, a fourth embodiment of the electronic wristwatch according to the present invention will be described.

As in the first embodiment, in this electronic wristwatch of the fourth embodiment the timepiece module 3 comprises the time-display hand unit and the first and second liquid crystal display units 9 and 10. Further, as in the third embodiment it has the third liquid crystal display unit 30.

As in the first embodiment, the second liquid crystal display unit 10 comprises the second reflective-type liquid crystal display panel 20 disposed below the dial plate 12 of the time-display hand unit 8, that is, below the electroluminescence element 17 so as to face its opening 17b. The second panel 20 is disposed within the housing 7 and supported at opposite ends by the pair of interconnectors 21 so as to be connected electrically to the circuit board 18. Thus, the second liquid crystal display unit 10 displays information such as time electro-optically so as to be visible from above through the opening 17b in the electroluminescence element 17, the dial plate 12 and the first liquid crystal display panel 15.

As in the third embodiment, in the third liquid crystal display unit 30 the third reflective-type liquid crystal display panel 31 which is slightly tiled to the surface of the first liquid crystal display panel 15 is disposed within the case 1 at the side of the first liquid crystal display panel 15 at six o'clock and supported by the pair of inter connectors 32 such that it is electrically connected to the circuit board 18. As in the third embodiment, the protective crystal 34 is provided as a part of the upper surface of the case 1 over the third panel 31. Thus, information displayed on the third panel 31 can be viewed from outside the case 1 through the protective crystal 34.

As in the first embodiment, in this electronic wristwatch time can be known from the time-display hand unit 8, and different information can be displayed on both the first and second liquid crystal display units 9 and 10. Further, other information can be displayed on the third panel 31 of the third liquid crystal display unit 30 and this information can be viewed through the protective crystal 34. Thus, as in the third embodiment more information is displayed to thereby display information on the multiple functions of the timepiece apparatus can be displayed compared to the first embodiment.

(Fifth Embodiment)

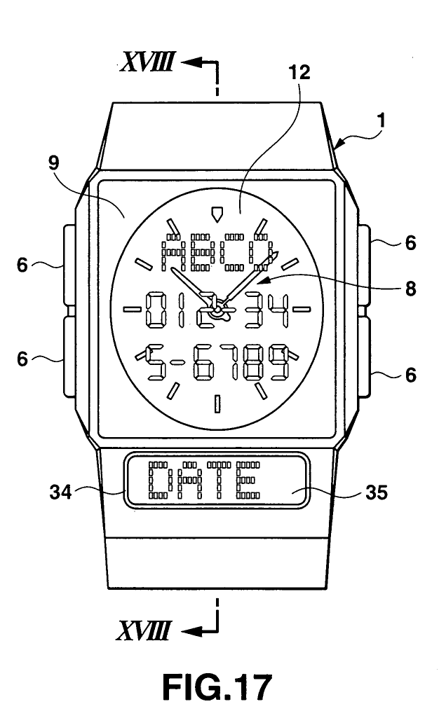

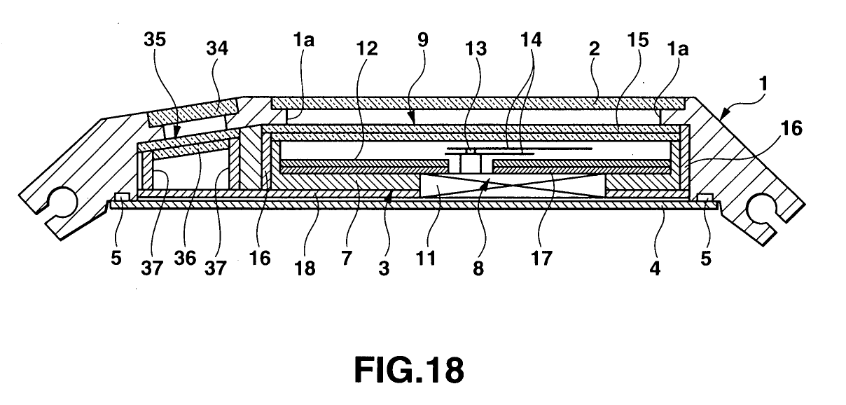

Next, referring to FIGS. 17 and 18, a fifth embodiment of the electronic wristwatch according to the present invention will be described.

In this electronic wristwatch, the first liquid crystal display unit 9 is disposed above the time-display hand unit 8 of the timepiece module 3 and the second liquid crystal display unit 35 is disposed at the side of the first liquid crystal display unit 9 at six o'clock with being slightly tilted to the surface of the first liquid crystal display unit 9. More particularly, the fifth embodiment has the same structure as the first embodiment about the time-display hand unit 8 and the first liquid crystal display unit 9 excluding the second liquid crystal display unit 35.

The second liquid crystal display unit 35 of the fifth embodiment has a reflective-type second liquid crystal display panel 36 having the same structure as the second liquid crystal display panel 20 of the first embodiment. The second liquid crystal display panel 36 is also disposed within the case 1 at the side of the first liquid crystal display panel 15 at six o'clock with being slightly tilted relative to the surface of the first liquid crystal display panel 15 and supported its both ends by the pair of interconnectors 37 so as to be connected electrically to the circuit board 18 to thereby display various information such as a telephone number electro-optically. In this case, the protective crystal 34 is provided above the second liquid crystal display panel 36 so as to compose a part of the case 1 as in the third embodiment. Thus, the second panel 36 is illuminated with external light entering through the protective crystal 34 and the displayed information can be viewed from outside the case 1 through the protective crystal 34 to thereby display information on the multiple functions of the timepiece apparatus.

As in the first embodiment, in this electronic wristwatch the first liquid crystal display unit 9 is disposed above the time-display hand unit 8, the second liquid crystal display unit 35 is disposed at the side of the first liquid crystal display unit 9 with being slightly tilted to the first liquid crystal display panel 15, as described above, such that the information displayed on the second liquid crystal display panel 36 of the second liquid crystal display unit 35 can be viewed from outside the case 1 through the protective crystal 34. Thus, time can be known from the time-display hand unit 8 and different information displayed on the first and second liquid crystal display units 9 and 35, respectively, can be viewed. Thus, as in the first embodiment more information can be displayed by a quantity of information provided by the second liquid crystal display unit 35 compared to the electronic wristwatch in which only the first liquid crystal display unit 9 is provided to display information in addition to the time-display hand unit 8. Thus, information on the multiple functions of the timepiece apparatus is displayed.

(Sixth Embodiment)

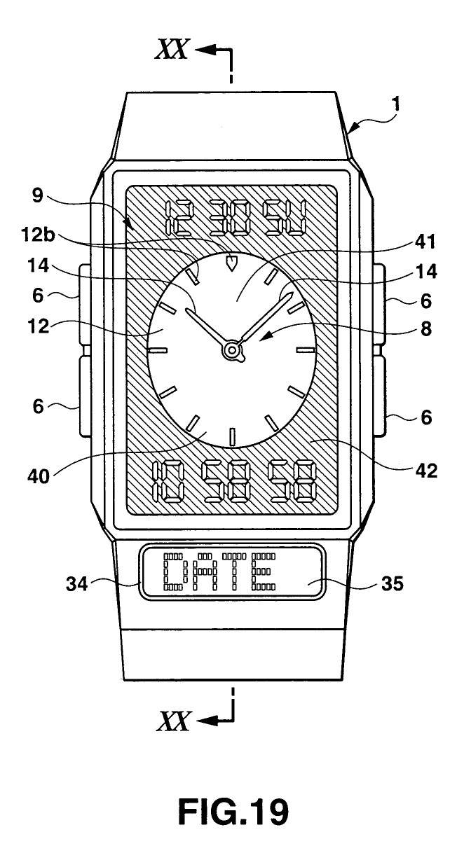

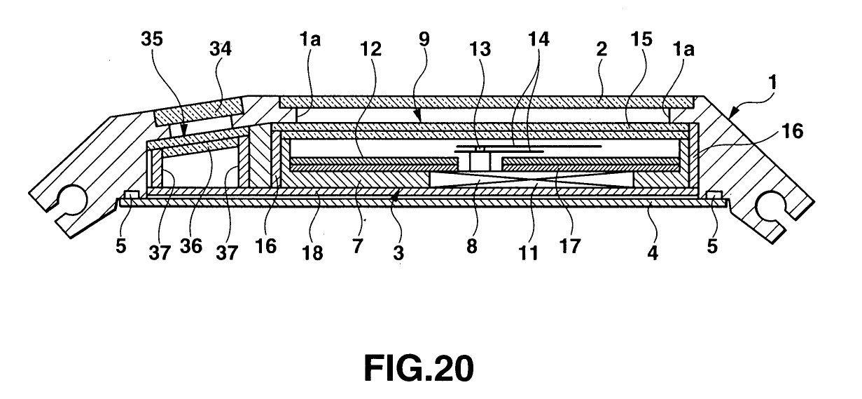

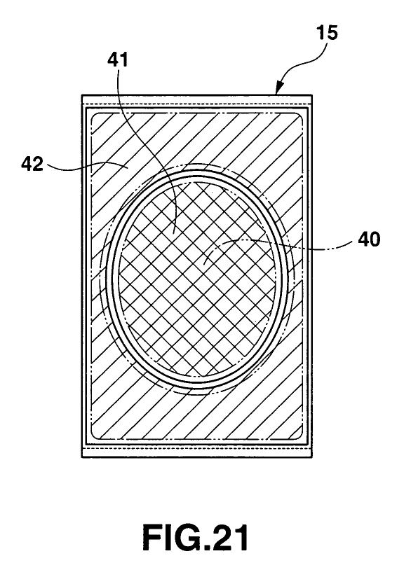

Then, referring to FIGS. 19-21, a sixth embodiment of the electronic wristwatch according to the invention will be described.

The electronic wristwatch of this embodiment has substantially the same structure as the fifth embodiment excluding that the dial plate 12 of the time-display hand unit 8 comprises a circular hour marker area 40. The first liquid crystal display panel 15 of the first liquid crystal display unit 9 comprises a first display area 41 corresponding to the hour marker area 40 of the dial plate 12 and a second display area 42 corresponding to the area of the dial plate 12 other than its hour marker area 40, in which the first and second display areas 41 and 42 present different display states, respectively.

In the first liquid crystal display panel 15, the first and second display areas 41 and 42 present positive and negative displays, respectively. More particularly, when no voltages are applied across the pair of transparent electrode plates, the first display area 41 presents an optically transparent state whereas when voltages are applied selectively across the pair of electrodes, the first display area 41 cuts off light to thereby display information only at points thereon to which voltages are applied. When no voltages are applied across the pair of electrode plates, the second display area 42 cuts off light whereas when voltages are applied selectively across the pair of electrode plates, only the points on the second display area 42 to which the voltages are applied allows light to pass therethrough to thereby display corresponding information.

As in the fifth embodiment, the second liquid crystal display unit 35 of the sixth embodiment comprises the second reflective-type liquid crystal display panel 36 that is disposed in the housing 7 at the side of the first liquid crystal display panel 15 at six o'clock with being slightly tilted to the surface of the first liquid crystal display panel 15 and supported so as to be electrically connected by the pair of interconnectors 37 to the circuit board 18 to thereby display various information such as a telephone number. Also, in this case the protective crystal 34 is provided above the second liquid crystal display panel 36 so as to form a part of the upper surface of the case 1.

As in the fifth embodiment, in this electronic wristwatch of the sixth embodiment time can be known from the time-display hand unit 8 and different information displayed on both the first and second liquid crystal display units 9 and 35, respectively, can be viewed. Thus, more information can be displayed. Especially, since the second display area 42 facing the area of the dial plate 12 other than the hour marker area 40 of the dial plate 12 presents the negative display, the hour marker area 40 is displayed in a brighter state than its outer area because the first display area 41 facing the hour marker area 40 presents the positive display even when the area of the dial plate 12 outside the hour marker area 40 is dark. Thus, the time indicated by the time-display hand unit 8 is made easier to view.

(Seventh Embodiment)

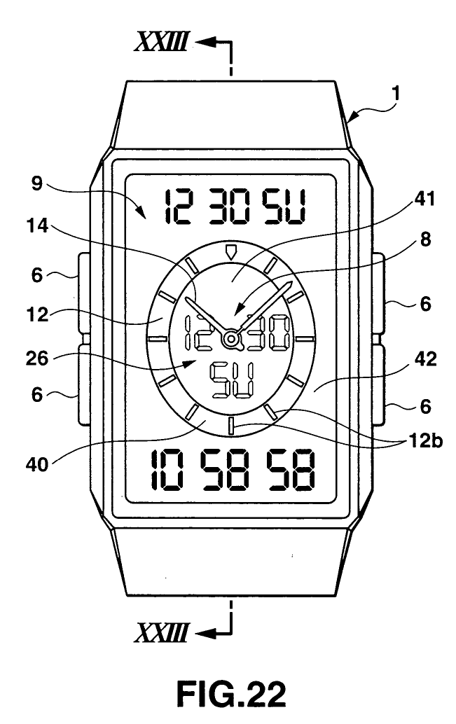

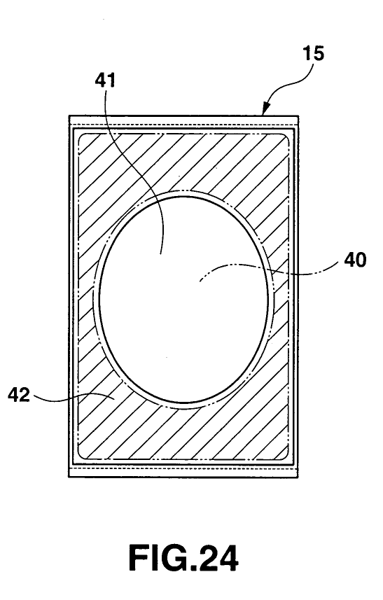

Next, referring to FIGS. 22-24, a seventh embodiment of the electronic wristwatch according to the present invention will be described.

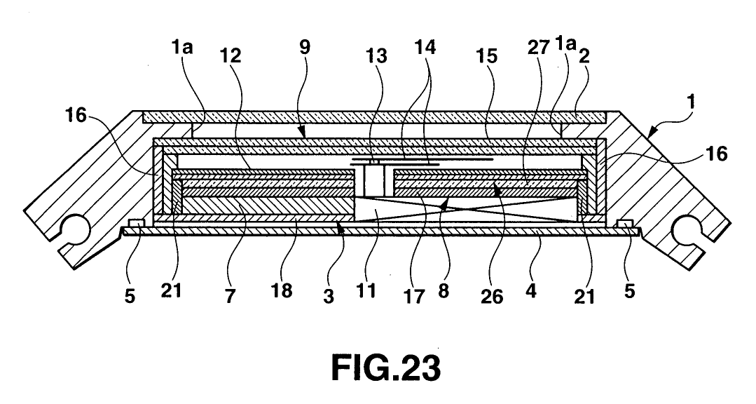

As shown in FIG. 23, the first liquid crystal display unit 9 is disposed above the time-display hand unit 8 of the timepiece module 3, and the second liquid crystal display unit 26 is disposed below the time-display hand unit 8. The first display area 41 facing the hour marker area 40 of the dial plate 12 and the second display area 42 facing the area of the dial plate 12 other than the hour marker area 40 are formed on the first liquid crystal display panel 15 of the first liquid crystal display unit 9.

Also in this case, the first display area 41 presents a positive display. When no voltages are applied across the pair of transparent electrode plates, the first display area 41 presents an optically transparent state whereas when voltages are applied selectively across the pair of electrode plates, the first display area 41 cuts off the light at points thereon to which the voltages are applied across the pair of electrode plates to thereby display information. The second display area 42 presents a negative display. When no voltages are applied across the pair of electrode plates, the second display area 42 cuts off the light whereas when the voltages are applied across the pair of electrode plates, points on the second display area 42 to which the voltages are applied allow the light to pass therethrough to thereby display information.

Like the sixth embodiment, the dial plate 12 is made of transparent or translucent plastic and has a central circular hour marker area 40. As in the second embodiment, in the second liquid crystal display unit 26 the second transparent-type liquid crystal display panel 27 is disposed on the whole lower surface of the dial plate 12 within the housing 7 and supported by the pair of inter connectors 21 so as to be electrically connected to the circuit board 18. Thus, information is displayed only on the area of the second liquid crystal display panel 27 facing the hour marker area 40 of the dial plate 12 and can be viewed from above through the dial plate 12 and the first display area 41 of the first liquid crystal display panel 15.

Like the sixth embodiment, in this electronic wristwatch time can be known from the time-display hand unit 8 and different information can be displayed on, and viewed from, both the first and second liquid crystal display units 9 and 26. Thus, more information is displayed to thereby display information on the multiple functions of the timepiece. Especially, the second display area 42 facing the area of the dial plate 12 other than the hour marker area 40 presents the negative display, so that even when the area of the dial plate 12 other than the hour marker area 40 is dark, the first display area 41 facing the hour marker area 40 presents the positive display. Thus, the hour marker area 40 of the time-display hand unit 8 is brighter than its outer area. Thus, the time indicated by the time-display hand unit 8 is made easier to view and the information displayed on the second liquid crystal display panel 27 can be viewed clearly through the first display area 41 of the first liquid crystal display panel 15.

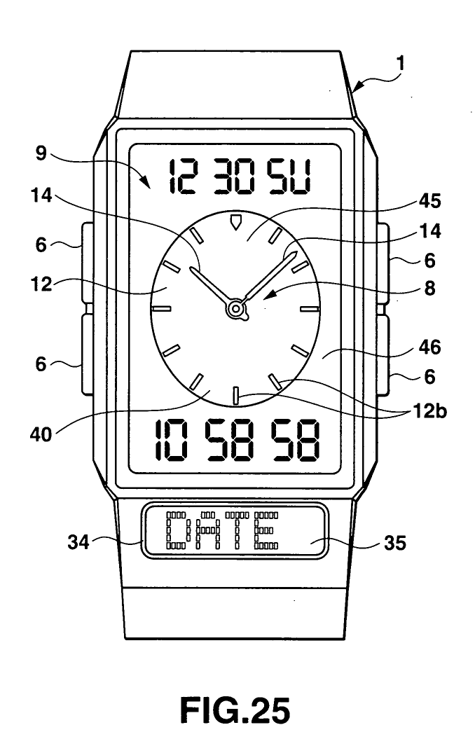

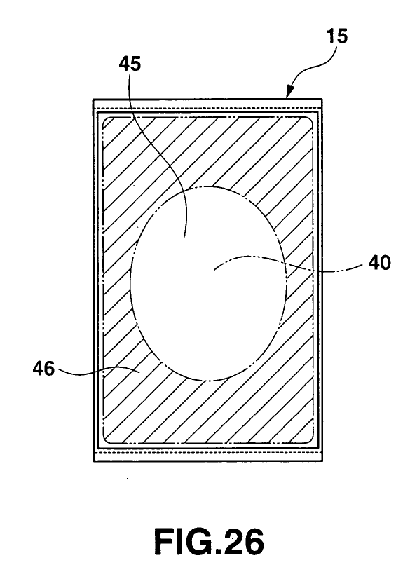

While in the sixth and seventh embodiments the first display area 41 that presents the positive display is provided in the first liquid crystal display panel 15 so as to face the hour marker area 40 of the dial plate 12 and the second display area 42 that presents the negative display is provided in the first liquid crystal display panel 15 so as to face the area of the dial plate 12 other than the hour marker area 40, the present invention is not limited to this arrangement. For example, as shown in FIGS. 25 and 26, the arrangement may be such that the first display area 45 facing the hour marker area 40 of the dial plate 12 comprises a non-display area that always presents a transparent state and the second display area 46 facing the area of the dial plate 12 other than its hour marker area 40 presents either a positive or a negative display.

In order that in this case the first display area 45 corresponding to the hour marker area 40 of the dial plate 12 always presents a transparent state, a pair of second electrodes having the same area as, and facing, the first display area 45 may be provided respectively on the opposite surfaces of the first-mentioned pair of electrode plates such that a certain fixed voltage is applied across the pair of second electrodes with the pair of the upper and lower polarizer plates provided respectively on the upper surface of the upper electrode plate and the lower surface of the lower electrode. Alternatively, the opposite surface portions of the pair of electrode plates that face the first display area 45 of the first liquid crystal panel 15 may be composed as non-electrode areas such that the first display area 45 has no display functions or always presents a transparent state. Alternatively, with the pair of electrode plates provided, at least one of the upper and lower polarizer plates may be eliminated to thereby cause the first display area 45 to present a transparent state or carry out no display functions. In this composition, even when the second display area 46 facing the area of the dial plate 12 other than the hour marker area 40 is constituted so as to present any one of the negative and positive displays to display information, the first display area 45 facing the hour marker area 40 always presents the transparent state. Thus, compared to the sixth embodiment the hour marker area 40 is made bright to thereby make the time indicated by the time-display hand unit easier to view.

While in the first to seventh embodiments and their modifications the electronic wristwatches have been illustrated, the present invention is not limited to these particular cases. For example, the present invention is widely applicable to electronic timepiece apparatus such as travel watches, alarm clocks, wall clocks and other clocks.

As described above, the electronic timepiece apparatus of the first to eighth embodiments of FIGS. 1 through 8 comprises the time-display hand unit 8 having hands 14 that sweep above the dial plate 12 thereof; the first liquid crystal display unit 9 disposed above the time-display hand unit for displaying information electro-optically; and the second liquid crystal display unit 10, 26 disposed below the time-display hand unit for displaying information electro-optically. The information displayed on the second liquid crystal display unit is visible from above the first liquid crystal display unit through the dial plate and the first liquid crystal display unit.

According to these embodiments, the first liquid crystal display unit is disposed above the time-display hand unit and the second liquid crystal display unit is disposed below the time-display hand unit. The information displayed on the second liquid crystal display unit is visible through the dial plate and the first liquid crystal display unit. Thus, the first and second liquid crystal display units can display information, which can be viewed. Therefore, compared to the electronic wristwatch in which only the first liquid crystal display unit displays information, the electronic wristwatch of the present embodiment is capable of displaying much information to thereby display information on the multiple functions thereof.

The electronic timepiece apparatus of the embodiments of FIGS. 9 through 16 comprises the third liquid crystal display unit 30 disposed substantially flush with the first liquid crystal display unit 9 beside this unit for displaying information electro-optically.

According to these embodiments, both the first and second liquid crystal display units are capable of displaying information. In addition, the third liquid crystal display unit disposed beside the first liquid crystal display unit is also capable of displaying information. Thus, the apparatus is capable of displaying much more information.

The electronic timepiece apparatus of the embodiments of FIGS. 17 to 18 comprises the time-display hand unit 8 having hands 14 that sweep above the dial plate 12 thereof; the first liquid crystal display unit 9 disposed above the time-display hand unit for displaying information electro-optically; and the second liquid crystal display unit 35 substantially flush with the first liquid crystal display unit beside this unit for displaying information electro-optically.

According to these embodiments, the first liquid crystal display unit disposed above the time-display hand unit is capable of displaying information. In addition, even the second liquid crystal display unit disposed beside the first liquid crystal display unit is capable of displaying information. Thus, more information is displayed by this embodiment to thereby display information on the multiple functions of the timepiece apparatus compared to the electronic timepiece in which only the first liquid crystal display unit displays information.

The electronic timepiece apparatus of the embodiments of FIGS. 19 to 26 comprises the time-display hand unit 8 having hands 14 that sweep above the dial plate 12 thereof; and the liquid crystal display unit 9 disposed above the time-display hand unit for displaying information electro-optically, wherein the liquid crystal display unit comprises the first display area 41, 45 that faces the hour marker area of the dial plate and the second display area 42, 46 that faces the area of the dial plate other than the hour marker area, the first and second display areas presenting different display states, respectively.

According to these embodiments, the liquid crystal display unit disposed above the time-display hand unit comprises the first display area that faces the hour marker area of the dial plate and the second display area that faces the area of the dial plate other than the hour marker area in which the first and second display areas present different display states. Thus, the optical permeability of the first display area can be made higher than that of the second display area to thereby made the hour marker area of the dial plate brighter to thereby make the hour marker area brighter. Thus, even when the liquid crystal display unit is disposed above the time-display hand unit, the time indicated by the time-display hand unit can be viewed well.

In the electronic timepiece apparatus of the embodiments of FIGS. 19 through 24, the first and second display areas 41, 42 are composed so as to present positive and negative displays, respectively.

According to these embodiments, the second display area facing the area of the dial plate other than its hour marker area presents the negative display. Thus, the area of the dial plate 12 outside the hour marker area is dark. However, since the first display area facing the hour marker area presents the positive display, the hour marker area is made brighter than its outer area to thereby make the time displayed by the time-display hand unit easier to view.

In the electronic timepiece apparatus of the embodiments of FIGS. 25 and 26, the first display area 45 comprises the non-display area that presents the transparent state and the second display area 46 comprises the area that presents any one of positive and negative displays.

According to these embodiments, even when the second display area facing the area of the dial plate other than its hour marker area is composed so as to present either a positive or a negative display state to thereby display information, the first display area facing the hour marker area always presents the transparent state. Thus, the hour marker area is made sufficiently bright to make the time indicated by the time-display hand unit easier to view.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. An electronic timepiece apparatus comprising:
a time-display hand unit having a dial plate and hands that sweep above the dial plate;
a first liquid crystal display unit which is disposed above the time-display hand unit; and
a second liquid crystal display unit which is disposed below the time-display hand unit,
wherein information displayed on the second liquid crystal display unit is visible from above the first liquid crystal display unit through the dial plate and the first liquid crystal display unit.

2. The electronic timepiece apparatus according to claim 1, further comprising a third liquid crystal display unit which is disposed at a side of the first liquid crystal display unit.

3. An electronic timepiece apparatus comprising:
a time-display hand unit having a dial plate and hands that sweep above the dial plate;
a first liquid crystal display unit disposed above the time-display hand unit; and
a second liquid crystal display unit which is disposed at a side of the first liquid crystal display unit.

4. An electronic timepiece apparatus comprising:
a time-display hand unit having a dial plate and hands that sweep above the dial plate; and
a liquid crystal display unit which is disposed above the time-display hand unit and comprises a first display area that faces a first area of the dial plate surrounded by hour markers arranged on the dial plate and a second display area that faces a second area of the dial plate other than the first area, the first and second display areas presenting different display states.

5. The electronic timepiece apparatus according to claim 4, wherein the first and second display areas present positive and negative displays, respectively.

6. The electronic timepiece apparatus according to claim 4, wherein the first display area comprises a non-display area that presents a transparent state and the second display area comprises an area that presents any one of positive and negative displays.
